(19) United States
(12) Patent Application Publication
(10) Pub. No.: US 2018/0130278 A1
(43) Pub. Date: May 10, 2018

(54) PAPER SHEET SORTING UNIT

(71) Applicant: HITACHI TERMINAL SOLUTIONS KOREA CO., LTD., Gyeonggi-do (KR)

(72) Inventor: Seon-Ho KIM, Gyeonggi-do (KR)

(21) Appl. No.: 15/573,424

(22) PCT Filed: Jan. 12, 2016
(86) PCT No.: PCT/KR2016/000262

§ 371 Date: Nov. 10, 2017

(30) Foreign Application Priority Data
May 15, 2015 (KR) 10-2015-0067863

(51) Int. Cl. G07D 11/00; B65H 29/64

(52) U.S. Cl. CPC G07D 11/0033; G07D 11/0084; B65H 2701/1912; B65H 2301/34; B65H 29/64

(57) ABSTRACT

A paper sheet sorting unit where a second guide path (2) is formed between the first sorting member (11) and the second sorting member (12), a first guide path (1) is formed on the exterior of the first sorting member (11), and a third guide path (3) is formed on the exterior of the second sorting member (12), the first sorting member (11) is driven by a power transmitted from an exterior to guide the paper sheets to the first guide path (1), the second sorting member (12) is driven by the power transmitted from the exterior to guide the paper sheets to the third guide path (3), and the first sorting member (11) and the second sorting member (12) are respectively driven in an opposite direction by the power transmitted from the exterior to guide the paper sheets to the second guide path (2).

### CROSS REFERENCE

The present application claims the benefit of Korean Patent Application No. 10-2015-0067863 filed in the Korean Intellectual Property Office on May 15, 2015, the entire contents of which are incorporated herein by reference.

### BACKGROUND

The present invention relates to a paper sheet sorting unit capable of guiding paper sheets to be transferred in any one of three directions.

In general, a paper sheet processing apparatus is to automatically count the number of paper sheets (e.g., a banknote, a check, or a valuable paper) by a mechanical device.

FIG. 1 is a cross-sectional view illustrating an internal configuration of a paper sheet processing apparatus according to the related art. As illustrated in the drawing, a housing 100 is provided with an inlet hopper 110 at an upper portion, and a plurality of discharge hoppers 120 which are spaced in a vertical direction, at a lower portion.

The inlet hopper 110 is provided with feeding rollers 200 to feed paper sheets stacked on the inlet hopper 110 into an inner space of the housing 100.

In order to transfer the paper sheets fed by the feeding rollers 200 to the respective discharge hoppers 120, guide plates 310 are installed in the inner space of the housing 110 to guide the paper sheets continuously from the inlet hopper 110 to the discharge hoppers 120. A plurality of transport rollers 320 are rotatably installed in the inner space of the housing 100 in a state of being adjacent to the guide plates 310, and are driven by operation of a driving member to transfer the paper sheet along the guide plates 310.

A sensing member 400 for detecting the paper sheets transferred along the guide plates 310, i.e., a counterfeit bill, a damaged bill, or a type, is installed in the inner space of the housing 100 in a state of being adjacent to the guide plate 310.

A sorting member 500 for sorting the paper sheets is installed in the inner space of the housing 100 in a state of being positioned between the guide plates 310. The sorting member rotates in a clockwise or counterclockwise direction according to discrimination of the sensing member 400, so that the paper sheets to be transferred along the guide plates 310 are dispersed to the discharge hoppers 120.

The sorting member 500 can guide the paper sheets to the discharge hoppers 120 in different directions, but cannot guide the paper sheets in another direction.

A related background technology of the present invention is disclosed in Korean Patent No. 10-1487447 (registered on Jan. 22, 2015).

### SUMMARY OF THE INVENTION

An object of the present invention is to provide a paper sheet sorting unit capable of guiding paper sheets to be transferred in any one of three directions.

According to one aspect of the present invention, there is provided a paper sheet sorting unit capable of sorting and guiding paper sheets to be transferred in any one of three directions, the paper sheet sorting unit including: a first sorting member and a second sorting member which are spaced apart from each other at a desired interval to sort paper sheets, wherein a second guide path is formed between the first sorting member and the second sorting member, a first guide path is formed on the exterior of the first sorting member, and a third guide path is formed on the exterior of the second sorting member, the first sorting member is driven by a power transmitted from an exterior to guide the paper sheets to the first guide path, the second sorting member is driven by the power transmitted from the exterior to guide the paper sheets to the third guide path, and the first sorting member and the second sorting member are respectively driven in an opposite direction by the power transmitted from the exterior to guide the paper sheets to the second guide path.

With the above configuration, the present invention can be applied to a paper sheet processing apparatus with three discharge hoppers, since the paper sheet sorting unit can guide the paper sheets in any one of three directions.

### BRIEF DESCRIPTION OF THE DRAWINGS

FIG. 1 is a cross-sectional view illustrating an internal configuration of a conventional paper sheet counter.

FIG. 2 is a plan view of a paper sheet sorting unit according to an embodiment of the present invention.

FIG. 3 is a view enlargedly illustrating a major portion of the paper sheet sorting unit according to the embodiment of the present invention.

FIG. 4 is a view illustrating an operating state of the paper sheet sorting unit according to the embodiment of the present invention.

FIG. 5 is a view illustrating other operating state of the paper sheet sorting unit according to the embodiment of the present invention.

FIG. 6 is a view illustrating another operating state of the paper sheet sorting unit according to the embodiment of the present invention.

FIG. 7 is a perspective view illustrating a state of connecting a discharge hopper with the paper sheet sorting unit according to the embodiment of the present invention.

FIG. 8 is a side view illustrating the state of connecting the discharge hopper with the paper sheet sorting unit according to the embodiment of the present invention.

FIG. 9 is a sectional view of FIG. 8.

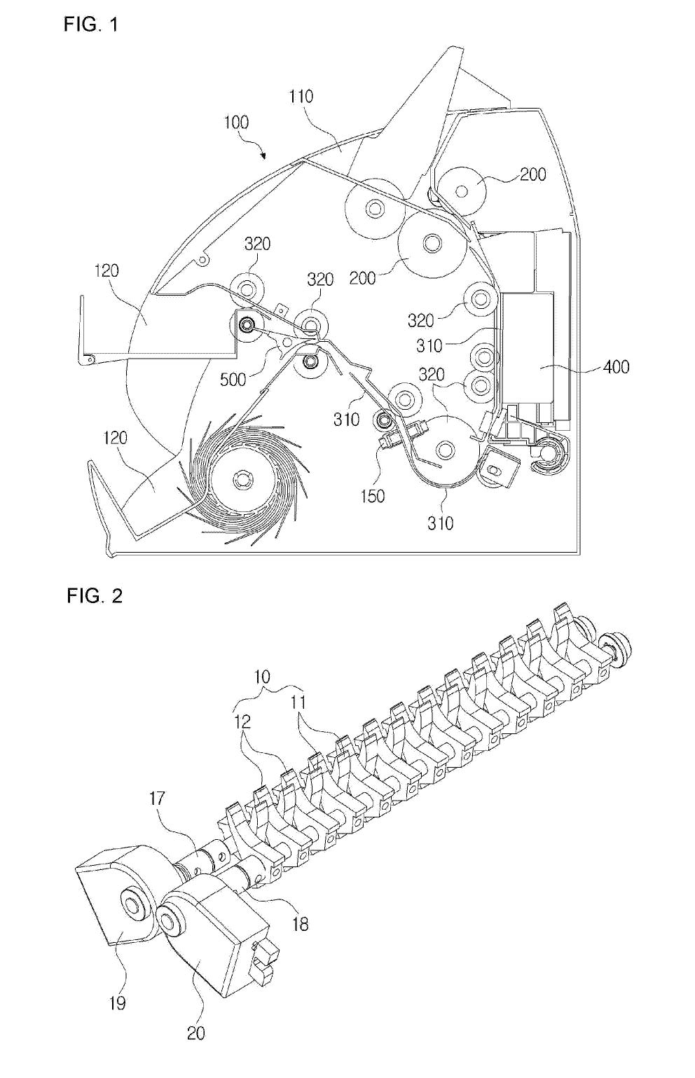

### DETAILED DESCRIPTION OF THE INVENTION

Hereinafter, the present invention will be described in detail with reference to the accompanying drawings.

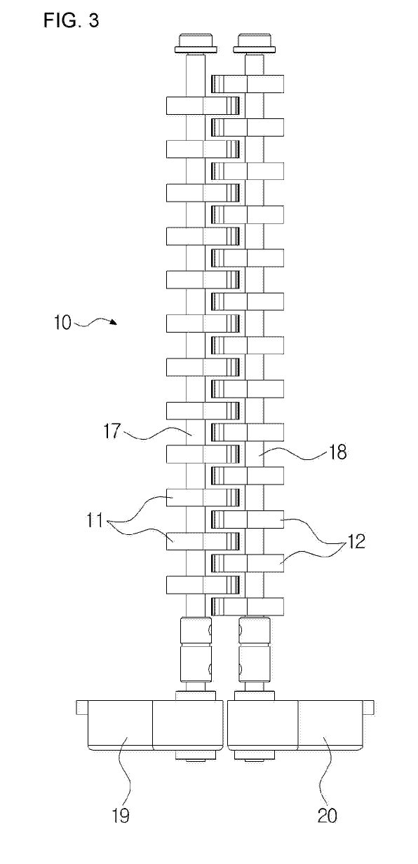

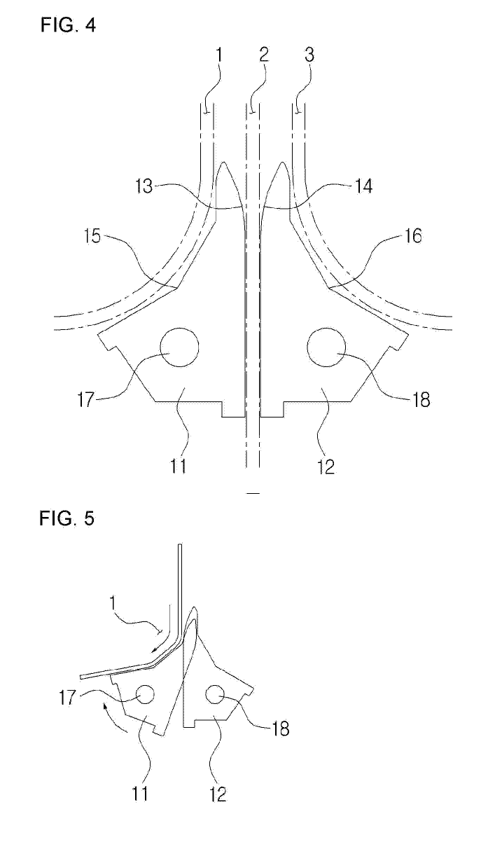

As illustrated in FIGS. 2 to 4, a paper sheet sorting unit 10 according to one embodiment of the present invention includes a first sorting member 11 and a second sorting member 12 which are spaced apart from each other at a desired interval to sort paper sheets. A second guide path 2 is formed between the first sorting member 11 and the second sorting member 12, a first guide path 1 is formed on the exterior of the first sorting member 11, and a third guide path 3 is formed on the exterior of the second sorting member 12. The first sorting member 11 is driven by the power transmitted from the exterior to guide the paper sheets to the first guide path 1. The second sorting member 12 is driven by the power transmitted from the exterior to guide the paper sheets to the third guide path 3. The first sorting member 11 and the second sorting member 12 are respectively driven in an opposite direction by the power transmitted from the exterior to guide the paper sheets to the second guide path 2.

The first sorting member 11 has a first one-side guide surface 13 extending from a sharp end to one side, and a first other-side guide surface 15 extending from the end to the other side. The first one-side guide surface 13 is formed in a convex shape, while the first other-side guide surface 15 is formed in a concave shape.

The second sorting member 12 has a second one-side guide surface 14 extending from a sharp end to one side, and a second other-side guide surface 16 extending from the end to the other side. The second one-side guide surface 14 is formed in a convex shape, while the second other-side guide surface 16 is formed in a concave shape.

The first sorting member 11 and the second sorting member 12 are symmetrically spaced apart from each other at a desired interval, and the first one-side guide surface 13 and the second one-side guide surface 14 are opposite to each other, and the first other-side guide surface 15 and the second other-side guide surface 16 face in an opposite direction.

Since the first sorting member 11 and the second sorting member 12 are spaced apart from each other at an interval larger than a thickness of the paper sheet so that the paper sheet easily passes, the second guide path 2 is formed between the first sorting member 11 and the second sorting member 12. The third guide path 3 may be formed on the exterior of the second sorting member 12. Specifically, the second guide path 2 is formed when the first one-side guide surface 13 and the second one-side guide surface 14 are opposite to each other and are spaced apart from each other, so that the paper sheet can pass through the second guide path 2.

A plurality of first sorting members 11 and a plurality of second sorting members 12 may be fixed to a first rotary shaft 17 and a second rotary shaft 18 which are respectively rotated in a clockwise or counterclockwise direction by the power transmitted from the exterior. In this instance, the first sorting members 11 and the second sorting members 12 are preferably spaced apart from each other at regular intervals, and are fixed to the rotary shafts 17 and 18 in a state of being arranged in line. Accordingly, when first sorting members 11 and the second sorting members 12 spaced apart from each other at a desired interval are respectively rotated in a clockwise or counterclockwise direction, the air is dispersed, which minimizes the effect of the air on the paper sheet.

The first rotary shaft 17 and the second rotary shaft 18 are connected to a first driving member 19 and a second driving member 20, respectively. The first driving member 19 and the second driving member 20 may be an electric motor or a solenoid to rotate the first rotary shaft 17 and the second rotary shaft 18, respectively. Specifically, the first driving member 19 and the second driving member 20 can be rotated in a clockwise or counterclockwise direction by a rotating force of the motor or solenoid.

Also, the first driving member 19 and the second driving member 20 may be a pinion or a roller which is connected to the first rotary shaft 17 and the second rotary shaft 18 to transmit the power (rotating force) transmitted from the exterior to the first rotary shaft 17 and the second rotary shaft 18, respectively. Specifically, if the rotating force is transmitted to the pinion or roller from the exterior, the first rotary shaft 17 and the second rotary shaft 18 can be respectively rotated.

As illustrated in FIG. 5, if the first sorting member 11 is rotated and thus the first other-side guide surface 15 closes the second guide path 2, the paper sheet to be transferred to the second guide path 2 can be guided to the first guide path 1 along the first other-side guide surface 15.

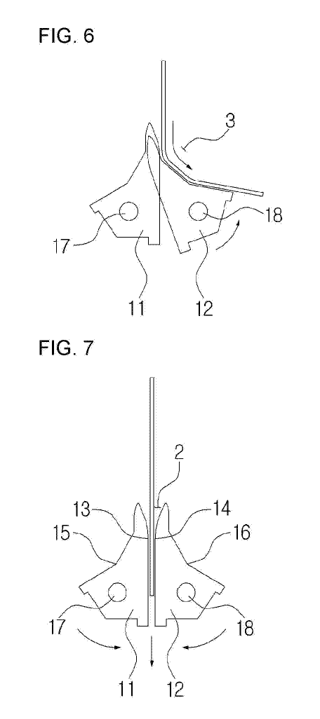

On the contrary, as illustrated in FIG. 6, if the second sorting member 12 is rotated and thus the second other-side guide surface 16 closes the second guide path 2, the paper sheets to be transferred to the second guide path 2 can be guided to the third guide path 3 along the second other-side guide surface 16.

Also, as illustrated in FIG. 7, if the first sorting member 11 and the second sorting member 12 are respectively rotated in an opposite direction, the first other-side guide surface 15 and the second other-side guide surface 16 open the second guide path 2, so that the paper sheet can be guided to the second guide path 2, while both sides thereof are guiding by the first one-side guide surface 13 and the second one-side guide surface 14.

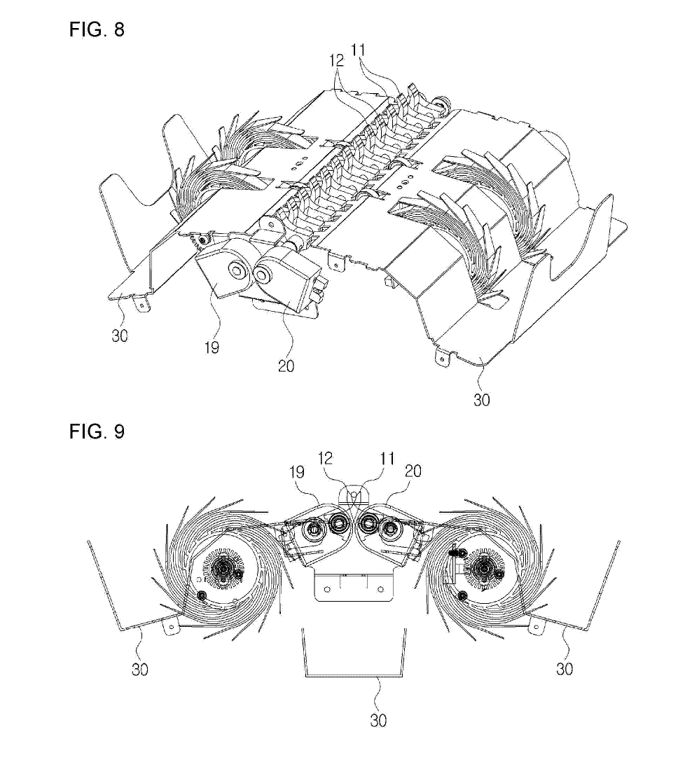

As illustrated in FIGS. 8 and 9, the discharge hoppers 30, on which the paper sheets are stacked, are separately positioned at both sides, and continuously extend to the first guide path 1 and the third guide path 3. The second guide path 2 may be provided with the discharge hopper 30.

Therefore, the paper sheets to be transferred along the first guide path 1, the second guide path 2, and the third guide path 3 are respectively dispersed in different directions, and then are stacked on the respective discharge hoppers 30.

Alternatively, the second guide path 2 may be provided with a dispersing member (not illustrated) to distribute the paper sheets in different directions, instead of the discharge hopper 30. Accordingly, the paper sheets can be dispersed in different directions by a dispersing operation of the dispersing member. Of course, if the discharge hoppers 30 are provided at different directions, the paper sheets can be stacked on the respective discharge hoppers.

As described above, since the present invention is configured to discharge the paper sheets to the front side or both sides of the housing, the whole volume thereof can be minimized. Therefore, the present invention is very useful to be applied to a paper sheet sorting unit, such as a paper sheet ATM or a paper sheet counter.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A paper sheet sorting unit (10) capable of sorting and guiding paper sheets to be transferred in any one of three directions, the paper sheet sorting unit comprising:
a first sorting member (11) and a second sorting member (12) which are spaced apart from each other at a desired interval to sort paper sheets,
wherein a second guide path (2) is formed between the first sorting member (11) and the second sorting member (12), a first guide path (1) is formed on the exterior of the first sorting member (11), and a third guide path (3) is formed on the exterior of the second sorting member (12),
the first sorting member (11) is driven by a power transmitted from an exterior to guide the paper sheets to the first guide path (1),
the second sorting member (12) is driven by the power transmitted from the exterior to guide the paper sheets to the third guide path (3), and
the first sorting member (11) and the second sorting member (12) are respectively driven in an opposite direction by the power transmitted from the exterior to guide the paper sheets to the second guide path (2).

2. The paper sheet sorting unit (10) according to claim 1, wherein the first sorting member (11) has a first one-side guide surface (13) extending from a sharp end to one side, and a first other-side guide surface (15) extending from the end to the other side, and
The second sorting member (12) has a second one-side guide surface (14) extending from a sharp end to one side, and a second other-side guide surface (16) extending from the end to the other side.

3. The paper sheet sorting unit (10) according to claim 2, wherein the first one-side guide surface (13) is formed in a convex shape, while the first other-side guide surface (15) is formed in a concave shape,
the second one-side guide surface (14) is formed in a convex shape, while the second other-side guide surface (16) is formed in a concave shape,
the first one-side guide surface (13) and the second one-side guide surface (14) are opposite to each other, and
the first other-side guide surface (15) and the second other-side guide surface (16) face in an opposite direction.

4. The paper sheet sorting unit (10) according to claim 1, wherein the first sorting member (11) and the second sorting member (12) are spaced apart from each other at an interval larger than a thickness of the paper sheet.

5. The paper sheet sorting unit (10) according to claim 1, wherein a plurality of first sorting members (11) and a plurality of second sorting members (12) are fixed to a first rotary shaft (17) and a second rotary shaft (18) which are respectively rotated in a clockwise or counterclockwise direction by the power transmitted from the exterior.

6. The paper sheet sorting unit (10) according to claim 1, wherein the first sorting members (11) and the second sorting members (12) are spaced apart from each other at regular intervals, and are fixed to the rotary shafts (17 and 18) in a state of being arranged in line.
